(19) United States
(12) Patent Application Publication
(10) Pub. No.: US 2004/0209775 A1
(43) Pub. Date: Oct. 21, 2004

(54) Herbicidal composition

(76) Inventors: Jurgen Schaetzer, Basel (CH); Jean Wenger, Basel (CH); Roger Graham Hall, Basel (CH); Kurt Nebel, Basel (CH); Stephen John Hole, Stein (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/484,746

(22) PCT Filed: Jul. 23, 2002
(86) PCT No.: PCT/EP02/08203

(30) Foreign Application Priority Data
Jul. 24, 2001 (CH) 1377/01

(51) Int. Cl. A01N 47/40; A01N 47/28

(52) U.S. Cl. 504/141; 504/148

(57) ABSTRACT

A herbicidal composition that, in addition to comprising customary inert formulation adjuvants, comprises a) a compound of formula (I) wherein the substituents R, R₁, R₂, R₃ and R₄, and the suffixes n and m are as defined in claim 1, or an agronomically acceptable salt of such a compound, and b) a synergistically effective amount of one or more co-herbicides. The compositions according to the invention may additionally comprise a safener.

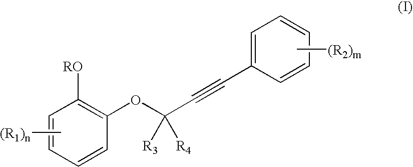

The present invention relates to a novel herbicidal composition comprising a herbicidal active ingredient combination that is suitable for the selective control of weeds in crops of useful plants, for example in crops of cotton, soybeans, sugar beet, sugar cane, plantation crops, rape and, especially, cereals, rice and maize. The invention relates also to a method of controlling weeds in crops of useful plants, and to the use of the novel composition for that purpose.

The compound of formula I

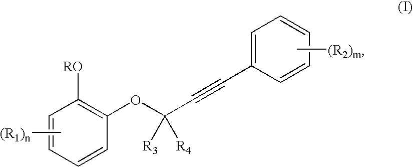

wherein the substituents R and R₁ to R₄ and the suffixes n and m are as defined hereinbelow, has herbicidal activity.

The compound of formula I and its preparation are described, for example, in WO 01/55066.

Surprisingly, it has now been found that a combination of variable amounts of active ingredients, that is to say of an active ingredient of formula I with one or more of the herbicidal active ingredients listed below, which are known and some of which are also commercially available, exhibits a synergistic action that is capable of controlling, both pre-emergence and post-emergence, the majority of weeds occurring especially in crops of useful plants.

There is therefore proposed in accordance with the present invention a novel synergistic composition for selective weed control that, in addition to comprising customary inert formulation adjuvants, comprises as active ingredient a mixture of

a) a herbicidally effective amount of a compound of formula I

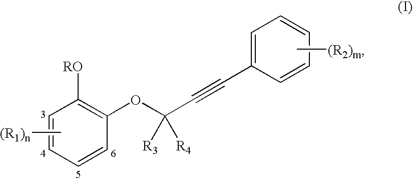

wherein

R is H, —COR₁₂, —S(O)_{q}C₁₋₈alkyl, C₁₋₈alkyl which is unsubstituted or substituted by one or more substituents selected from halogen, C₁₋₄alkoxy, —CN, —S(O)_{q}C₁₋₈alkyl and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, C₃₋₈alkenyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, C₃₋₈alkynyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, C₃₋₆cycloalkyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, or phenyl which is unsubstituted or substituted by one or more substituents selected from halogen, —CH₃, —CF₃, —OCH₃, —CN, —NO₂ and —S(O)_{q}C₁₋₈alkyl; and,

when n is 0, 1, 2 or 3, R may, in addition, form a C₁₋₆alkylene bridge which is uninterrupted or interrupted by 1 O atom, the possibility of an —O—O— bond being excluded, and that bridge, fused onto the benzene ring, forming a 5- to 9-membered ring which may in turn be substituted by C₁₋₆alkyl, or may form a C₂₋₆alkenylene bridge which is uninterrupted or Interrupted by 1 O atom, the possibility of an —O—O— bond being excluded, and that bridge, fused onto the benzene ring, forming a 5- to 9-membered ring which may in turn be substituted by C₁₋₆alkyl, the said alkylene or alkenylene bridge being bonded to the benzene ring at the 3-position;

R₁ is halogen, —CN, —SCN, —SF₅, —NO₂, —NR₅R₆, —CO₂R₇, —CONR₈R₉, —C(R₁₀)═NOR₁₁, —COR₁₂, —XR₁₃, C₁₋₈alkyl which is unsubstituted or substituted by one or more substituents selected from halogen, —CN, —NO₂, —NR₅R₆, —CO₂R₇, —CONR₈R₉, —COR₁₂, —C(R₁₀)═NOR₁₁, —C(S)NR₈R₉, —C(S-C₁₋₄alkyl)═NR₈, —XR₁₃ and C₃₋₆cycloalkyl, C₂₋₈alkenyl which is unsubstituted or substituted by one or more substituents selected from halogen, —CN, —NO₂, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, C₂₋₈alkynyl which is unsubstituted or substituted by one or more substituents selected from halogen, —CN, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, C₃₋₆cycloalkyl which is unsubstituted or substituted by one or more substituents selected from halogen, —CN, —CO₂R₇, —CONR₈R₉, —COR₁₂, —C(R₁₀)═NOR₁, —C(S)NR₈R₉ and —C(S—C₁₋₄alkyl)═NR₈, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl; or

two adjacent R₁ radicals together form a C₁₋₇alkylene bridge which may be interrupted by 1 or 2 non-adjacent O atoms and that bridge, fused onto the benzene ring, forms a 5- to 9-membered ring which may be substituted by C₁₋₆alkyl; or

two adjacent R₁ radicals together form a C₂₋₇alkenylene bridge which may be interrupted by 1 or 2 non-adjacent O atoms and that bridge, fused onto the benzene ring, forms a 5- to 9-membered ring which may be substituted by C₁₋₆alkyl;

R₂ is halogen, —CN, —SCN, —SF₅, —NO₂, —NR₅R₆, —CO₂R₇, —CONR₈R₉, —C(R₁₀)═NOR₁₁, —COR₁₂, —XR₁₃, —OR₁₆, —N([CO]ₚR₁₇)COR₁₇, —N(OR₁₇)COR₁₇, —N(R₁₇)CO₂R₁₇, —N-phthalimide, C₁₋₈alkyl which is unsubstituted or substituted by one or more substituents selected from halogen, —CN, —NO₂, —NR₅R₆, —CO₂R₇, —CONR₈R₉, —COR₁₂, —C(R₁₀)═NOR₁₁, —C(S)NR₈R₉, —C(S—C₁₋₄alkyl)═NR₈, —XR₁₃, —N(R₁₄)CO₂R₁₅, —N(R₁₄)COR₁₅ and C₃₋₆cycloalkyl, C₂₋₈alkenyl which is unsubstituted or substituted by one or more substituents selected from halogen, —CN, —NO₂, —CO₂R₇, —CONR₈R₉, —COR₁₂, —C(R₁₀)═NOR₁₁, —C(S)NR₈R₉, —C(S—C₄alkyl)═NR₈ and C₃₋₆cycloalkyl, C₂₋₈alkynyl which is unsubstituted or substituted by one or more substituents selected from halogen, —CN, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, or C cycloalkyl which is unsubstituted or substituted by one or more substituents selected from halogen, —CN, —CO₂R₇, —CONR₈R₉, —COR₁₂, —C(R₁₀)═NOR₁₁, —C(S)NR₈R₉ and —C(S—C₁₋₄alkyl)═NR₈; or

two adjacent R₂ radicals together form a C₁₋₇alkylene bridge which may be interrupted by 1 or 2 non-adjacent O atoms and that bridge, fused onto the benzene ring, forms a 5- to 9-membered ring which may be substituted by C₁₋₆alkyl; or

two adjacent R₂ radicals together form a C₂₋₇alkenylene bridge which may be interrupted by 1 or 2 non-adjacent O atoms and that bridge, fused onto the benzene ring, forms a 5- to 9-membered ring which may be substituted by C₁₋₆alkyl;

R₅ is H or C₁₋₈alkyl;

R₆ is H, CO₁₋₈alkyl, C₃₋₈alkenyl, C₃₋₈alkynyl, benzyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl; or

R₅ and R₆ together form a C₂₋₅alkylene bridge;

R₇ is H, C₁₋₈alkyl which is unsubstituted or substituted by one or more substituents selected from halogen and C₁₋₄alkoxy, C₃₋₈alkenyl which is unsubstituted or substituted one or more times by halogen, C₃₋₈alkynyl which is unsubstituted or substituted one or more times by halogen, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl;

R₈ is H or C₁₋₈alkyl;

R₉ is H, CO₁₋₈alkyl which is unsubstituted or substituted by one or more substituents selected from —CO₂R₈ and —CN, C₃₋₈alkenyl, C₃₋₈alkynyl, C₁₋₄alkoxy, benzyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl; or

R₈ and R₉ together form a C₂₋₅alkylene bridge;

R₁₀ is H, C₁₋₄alkyl, halo-C₁₋₄alkyl or C₁₋₆cycloalkyl;

R₁₁ is H, C₁₋₈alkyl, C₃alkenyl, C₃₋₈alkynyl or halo-C₁₋₄alkyl;

R₁₂ is H, C₁₋₄alkyl, halo-C₁₋₄alkyl or C₃₋₆cycloalkyl;

R₁₃ is C₁₋₈alkyl which is unsubstituted or substituted by one or more substituents selected from halogen, —CN and C₁₋₄alkoxy, C₃₋₈alkenyl or C₃₋₈alkynyl or, provided that X is —O— or —S—, R₁₃ may, in addition, be H;

R₁₄ is H, C₁₋₈alkyl or C₁₋₈alkoxy;

R₁₅ is H or CO₁₋₈alkyl;

R₁₆ is C₀₋₆alkylphenyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl;

R₁₇ is H, C₁₋₈alkyl or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl;

X is —O—, —S—, —SO—, —S(O₂)— or —OS(O₂)—;

R₃ and R₄, each independently of the other, is H, halogen, —CN, C₁₋₄alkyl or C₁₋₄alkoxy; or

R₃ and R₄ together form a C₂₋₅alkylene bridge;

n is 0, 1, 2, 3 or 4;

m is 0, 1, 2, 3, 4 or 5; the sum of n and m being 1 or more than 1;

p is 0 or 1; and

q is 0, 1 or 2,

or an agronomically acceptable salt of such a compound, and

b) a synergistically effective amount of one or more compounds selected from the group consisting of the co-herbicides:

triasulfuron (773), prosulfuron (657), clodinafop-propargyl (156), terbutryn (740), dicamba (222), fenoxaprop-P-ethyl (331), metamifop, diclofop-methyl (232), tralkoxydim (767), butroxydim (104), amidosulfuron (24), chlorsulfuron (146), ethoxysulfuron (307), flupyrsulfuron (374), flupyrsulfuron-methyl-sodium (374), metsulfuron-methyl (536), sulfosulfuron (714), thifensulfuron-methyl (754), tribenuron-methyl (778), imazamethabenz-methyl (438), flucarbazone-sodium (357), iodosulfuron-methyl-sodium (454), florasulam (351), flumetsulam (366), metosulam (533), chlorotoluron (142), isoproturon (464), methabenzthiazuron (510), bromoxynil (93), ioxynil (455), pyridate (672), bifenox (75), fluoroglycofen-ethyl (371), carfentrazone-ethyl (119), fluazolate (355), diflufenican (245), flurtamone (382), glyphosate (407), sulfosate (407), glufosinate (406), S-glufosinate, bialaphos (bilanafos; (77)), ethalfluralin (298), pendimethalin (599), 2,4-DB (211), dichlorprop (2,4-DP; (228)), MCPA (485), MCPB (487), mecoprop (MCPP; (489)), mecoprop-P (490), clopyralid (162), fluroxypyr (380), quinmerac (682), benazolin-ethyl (59), difenzoquat metilsulfate (242), cyhalofop-butyl (191), trifluralin (791), fluthiamide (flufenacet; (362)), isoxaben (466), prosulfocarb (656), triallate (772), 2,4-D (205); benfluamid, cinidon-ethyl (152), flufenpyr, picolinafen (code no. AC 900001; (621)), propoxycarbazone (code no. MKH 6561; (541)); pretilachlor (632), cinosulfuron (154), fenclorim (325), pyriftalid (code no. CGA 279 233), metolachlor (529), S-metolachlor (530), mixtures of metolachlor and S-metolachlor, preferably mixtures thereof that contain 50-90%, especially 70-90%, S-metolachlor, bensulfuron-methyl (66), imazosulfuron (444), pyrazosulfuron-ethyl (665), azimsulfuron (45), esprocarb (296), mefenacet (491), molinate (542), propanil (644), pyrazolate (pyrazolynate; (663)), fenoxaprop-ethyl (“The Pesticide Manual”, Editor C. Tomlin, 10th Edition, British Crop Protection Council, 1994, entry no. (299)), bispyribac (82), bispyribac-sodium (82), pyriminobac-methyl (676), cafenstrole (108), oxaziclomefone (code no. MY-100; (583)), dymron (daimuron; (207)), fentrazamide (code no. NBA 061; (340)), indanofan (code no. MK243; (450)), etobenzanid (code no. HW-52; (311)), oxadiargyl (578), halosulfuron-methyl (414), clomazone (159), oxadiazon (579), benzobicyclon (code no. SAN1315H; (70)), mefenpyr-diethyl (492); profoxydim (code no. BAS 625H; (54)), pyrazogyl; cyclosulfamuron (186), flazasulfuron (349), flufenacet (362), benfuresate (63), bentazone (69), bromobutide (91), dithiopyr (275), ethametsulfuron-methyl (299), flamprop-M (348), methyldymron (521), quinclorac (681), thiazopyr (752) and mesosulfuron.

The above herbicidal active ingredients under b) are known and described, for example, in “The Pesticide Manual”, Editor C. D. S. Tomlin, 12th Edition, British Crop Protection Council, 2000, under the entry numbers added in brackets; for example, triasulfuron (773) is described therein under entry no. 773.

The S-enantiomer of glufosinate (406), S-glufosinate, is registered under CAS Reg. No. [35597-44-5].

Metamifop (Dongbu Hannong; code no. DBH 129) is known as a herbicide and is registered under CAS Reg. No. [256412-89-2].

Fluazolate (Monsanto; code no. JV-485, MON 48500) is also known as a herbicide under the common name isopropazole and is registered under CAS Reg. No. [174514-07-9].

The compound of formula 2.1

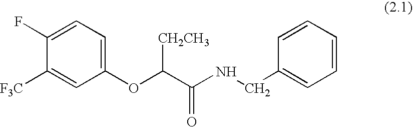

is known as a herbicide under the common name benfluamid (UBE; code no. UBH 820) and is registered under CAS Reg. No. [113604-08-7].

Flufenpyr is known as a herbicide and is registered under CAS Reg. No. [188489-06-7].

The compound of formula 2.2

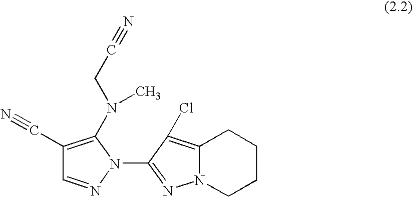

is known as a herbicide under the common name pyrazogyl (Aventis; code no. AEB 172391) and is registered under CAS Reg. No. [158353-15-2].

The compound of formula 2.3

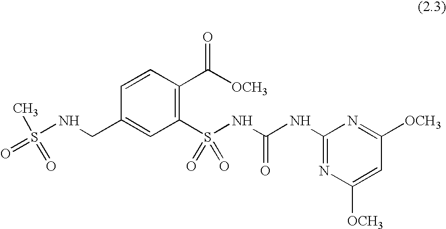

is known as a herbicide under the common name mesosulfuron (Aventis; code no. AEF 130060) and is registered under CAS Reg. No. [208465-21-8].

Pyriftalid and its preparation are described, for example, in EP-B-0 447 506.

The invention also includes the salts that the compounds of formula I having acid hydrogen, especially the derivatives having carboxylic acid groups (e.g. carboxyl-substituted alkyl, alkenyl and alkynyl groups), are able to form with amines, alkali metal and alkaline earth metal bases or quaternary ammonium bases. Among the alkali metal and alkaline earth metal hydroxides used as salt formers, emphasis is to be given to the hydroxides of lithium, sodium, potassium, magnesium and calcium, but especially to those of sodium and potassium.

Examples of suitable amines for ammonium salt formation that come into consideration are ammonia as well as primary, secondary and tertiary C₁-C₁₈alkylamines, C₁-C₄hydroxyalkyl-amines and C₂-C₄alkoxyalkylamines, for example methylamine, ethylamine, n-propylamine, isopropylamine, the four butylamine isomers, n-amylamine, isoamylamine, hexylamine, heptylamine, octylamine, nonylamine, decylamine, pentadecylamine, hexadecylamine, heptadecylamine, octadecylamine, methyl-ethylamine, methyl-isopropylamine, methyl-hexylamine, methyl-nonylamine, methyl-pentadecylamine, methyl-octadecylamine, ethyl-butylamine, ethyl-heptylamine, ethyl-octylamine, hexyl-heptylamine, hexyl-octylamine, dimethylamine, diethylamine, di-n-propylamine, diisopropylamine, di-n-butylamine, di-n-amylamine, diisoamylamine, dihexylamine, diheptylamine, dioctylamine, ethanolamine, n-propanolamine, isopropanolamine, N,N-diethanolamine, N-ethylpropanolamine, N-butyl-ethanolamine, allylamine, n-butenyl-2-amine, n-pentenyl-2-amine, 2,3-dimethylbutenyl-2-amine, dibutenyl-2-amine, n-hexenyl-2-amine, propylenediamine, trimethylamine, triethylamine, tri-n-propylamine, triisopropylamine, tri-n-butylamine, triisobutylamine, tri-sec-butylamine, tri-n-amylamine, methoxyethylamine and ethoxyethylamine; heterocyclic amines, for example pyridine, quinoline, isoquinoline, morpholine, piperidine, pyrrolidine, indoline, quinuclidine and azepine; primary aryl amines, for example anilines, methoxyanilines, ethoxyanilines, o-, m- and p-toluidines, phenylenediamines, benzidines, naphthylamines and o-, m- and p-chloroanilines; but especially triethylamine, isopropylamine and diisopropylamine.

Preferred synergistic mixtures according to the invention comprise as active ingredient a compound of formula I wherein R is H or C₁₋₄alkyl unsubstituted or substituted by one or more substituents selected from halogen and —CN.

Mixtures according to the invention that are also preferred comprise a compound of formula I wherein R₁ is halogen, —C(R₁₀)═NOR₁₁ or C₁₋₄alkyl unsubstituted or substituted by one or more substituents selected from halogen and —CN; R₁₀ is H or C₁₋₄alkyl; and R₁₁ is C₁₋₈alkyl.

Synergistic mixtures according to the invention that are likewise preferred comprise as active ingredient a compound of formula I wherein R₂ is halogen or C₁₋₄alkyl unsubstituted or substituted by one or more substituents selected from halogen and —CN.

Further preferred synergistic mixtures according to the invention comprise as active ingredient a compound of formula I wherein R₃ and R₄, each independently of the other, are H or C₁₋₄alkyl.

Preference is further given to synergistic mixtures according to the invention wherein, in the compound of formula I, n is 0, 1 or 2; m is 0, 1, 2, 3 or 4; and the sum of n and m is 1 or more than 1.

Further preferred synergistic mixtures according to the invention comprise a compound of formula I wherein R is H or C₁₋₄alkyl unsubstituted or substituted by one or more substituents selected from halogen and —CN; R₁ is halogen, —C(R₁₀)═NOR₁₁ or C₁₋₄alkyl unsubstituted or substituted by one or more substituents selected from halogen and —CN; R₂ is halogen or C₁₋₄alkyl unsubstituted or substituted by one or more substituents selected from halogen and —CN; R₁₀ is H or C₁₋₄alkyl; R₁₁ is C₁₋₈alkyl; R₃ and R₄, each independently of the other, are H or C₁₋₄alkyl; n is 0, 1 or 2; m 0, 1, 2, 3 or 4; and the sum of n and m is 1 or more than 1.

Preferred synergistic mixtures according to the invention for the control of weeds and grasses in crops of cereals comprise, as co-herbicides under b), compounds selected from the group: triasulfuron, prosulfuron, clodinafop-propargyl, terbutryn, fenoxaprop-P-ethyl, diclofop-methyl, tralkoxydim, butroxydim, amidosulfuron, chlorsulfuron, ethoxysulfuron, flupyrsulfuron-methyl-sodium, metsulfuron-methyl, sulfosulfuron, thifensulfuron-methyl, tribenuron-methyl, imazamethabenz-methyl, flucarbazone-sodium, iodosulfuron-methyl-sodium, florasulam, flumetsulam, metosulam, chlorotoluron, methabenzthiazuron, bromoxynil, pyridate, bifenox, fluoroglycofen-ethyl, carfentrazone-ethyl, fluazolate, cyhalofopbutyl, azimsulfuron, bensulfuron-methyl, cinosulfuron, cyclosulfamuron, fentrazamide, flazasulfuron, fluazolate, bentazone, ethametsulfuron-methyl, halosulfuron-methyl, quinclorac, imazosulfuron, pyrazosulfuron-ethyl, benfluamid, cinidon-ethyl, flufenpyr, picolinafen and propoxycarbazone.

Preferred synergistic mixtures according to the invention for the control of weeds and grasses in crops of rice comprise, as co-herbicides under b), compounds selected from the group: pretilachlor, cinosulfuron, triasulfuron, fenclorim, pyriftalid, clodinafop-propargyl, metolachlor, S-metolachlor, mixtures of metolachlor and S-metolachlor, preferably mixtures thereof that contain 50-90%, especially 70-90%, S-metolachlor, bensulfuron-methyl, imazosulfuron, pyrazosulfuron-ethyl, metsulfuron-methyl, azimsulfuron, mefenacet, cyhalofop-butyl, fenoxaprop-ethyl, fenoxaprop-P-ethyl, cafenstrole, glyphosate, S-glufosinate, glufosinate, sulfosate, halosulfuron-methyl, oxadiazon, mefenpyr-diethyl, indanofan, profoxydim and pyrazogyl.

Further preferred synergistic mixtures according to the invention for the control of weeds and grasses in crops of cereals and rice comprise, as co-herbicides under b), compounds selected from the group: amidosulfuron, azimsulfuron, bensulfuron-methyl, bromoxynil, carfentrazone-ethyl, chlorsulfuron, cinosulfuron, clodinafop-propargyl, cyclosulfamuron, cyhalofop-butyl, dicamba, diclofop-methyl, ethoxysulfuron, fenoxaprop-P-ethyl, flazasulfuron, florasulam, fluazolate, flufenacet, flupyrsulfuron, flupyrsulfuron-methyl-sodium, sulfosulfuron, thifensulfuron, triasulfuron, tribenuron-methyl, benfuresate, bentazone, bromobutide, dithiopyr, ethametsulfuron-methyl, flamprop-M, fluoroglycofen-ethyl, halosulfuron-methyl, mefenacet, methyldymron, pyridate, quinclorac, quinmerac, thiazopyr, tralkoxydim, imazosulfuron, indanofan, MCPA, MCPB, pyrazosulfuron-ethyl and mesosulfuron.

It is extremely surprising that the combination of the active ingredient of formula I with one or more active ingredients selected from the co-herbicides under b) exceeds the additive action on the weeds to be controlled that is to be expected in principle and thus broadens the range of action of the individual active ingredients especially in two respects: firstly, the rates of application of the individual compounds of formula I and co-herbicides under b) are reduced while a good level of action is maintained and, secondly, the composition according to the invention achieves a high level of weed control also in those cases where the individual substances, in the range of low rates of application, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Stellaria, Nasturtium, Agrostis, Digitaria, Avena, Setaria, Sinapis, Lolium, Solanum, Phaseolus, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica. The composition according to the invention is suitable for all methods of application conventionally used in agriculture, e.g. pre-emergence application, post-emergence application and seed dressing. The composition according to the invention is suitable especially for controlling weeds in crops of useful plants, such as rape, sugar beet, sugar cane, plantation crops, soybeans and, especially, cereals, rice and maize, and also for non-selective weed control.

“Crops” are to be understood to mean also those crops which have been made tolerant to herbicides or classes of herbicides as a result of conventional methods of breeding or genetic engineering.

The composition according to the invention comprises the compound of formula I and the co-herbicides under b) in any mixing ratio, but usually has an excess of one component over the other. Generally, the mixing ratios (ratios by weight) of the compound of formula I and the co-herbicides under b) are from 1:2000 to 2000:1, especially from 200:1 to 1:200.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 1 to 5000 g of active ingredient mixture/ha.

The mixtures of the compound of formula I with the co-herbicides under b) may be used in unmodified form, that is to say as obtained in synthesis. Preferably, however, they are formulated in customary manner, together with the adjuvants conventionally used in formulation technology, such as solvents, solid carriers or surfactants, for example into emulsifiable concentrates, directly sprayable or dilutable solutions, dilute emulsions, wettable powders, soluble powders, dusts, granules or microcapsules. As with the nature of the compositions, the methods of application, such as spraying, atomising, dusting, wetting, scattering or pouring, are chosen in accordance with the intended objectives and the prevailing circumstances.

The formulations, i.e. the compositions, preparations or mixtures comprising the compounds of formula I and the co-herbicides under b), and also, where appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6.

Depending on the nature of the compound of formula I to be formulated, suitable surface-active compounds are non-ionic, cationic and/or anionic surfactants and surfactant mixtures having good emulsifying, dispersing and wetting properties.

Examples of suitable anionic, non-ionic and cationic surfactants are listed, for example, in WO 97/34485, pages 7 and 8.

Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture comprising a compound of formula I together with the co-herbicides under b), from 1 to 99.9% by weight of a solid or liquid formulation adjuvant, and from 0 to 25% by weight, especially from 0.1 to 25% by weight, of a surfactant.

Whereas commercial products are usually formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions:

(%=percent by weight)

| | |
|---|---|
| Emulsifiable concentrates: | |
| active ingredient mixture: | 1 to 90%, preferably 5 to 20% |
| surfactant: | 1 to 30%, preferably 10 to 20% |
| liquid carrier: | 5 to 94%, preferably 70 to 85% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surfactant: | 1 to 40%, preferably 2 to 30% |
| Wettable powders: | |
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |
| Granules: | |
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

| F1. Emulsifiable concentrates | a) | b) | c) | d) |
|---|---|---|---|---|
| active ingredient mixture | 5% | 10% | 25% | 50% |
| calcium dodecylbenzene- | 6% | 8% | 6% | 8% |
| sulfonate | | | | |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon | 85% | 78% | 55% | 16% |
| mixture C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol mol. wt. 400 | 20% | 10% | — | — |
| N-methyl-2-pyrrolidone | — | — | 30% | 10% |
| arom. hydrocarbon | 75% | 60% | — | — |
| mixture C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly disperse silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly disperse silicic acid | 0.9% | 2% | 2% |
| inorg. carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol mol. wt. 200 | 1.0% | 2% | 3% |
| highly disperse silicic acid | 0.9% | 1% | 2% |
| inorg. carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compound of formula I and the mixing partner or partners under b) to be formulated separately and to be brought together in the desired mixing ratio in the applicator in the form of a “tank mixture” in water shortly before application.

### BIOLOGICAL EXAMPLES

A synergistic effect exists whenever the action of the active ingredient combination of compound of formula I and co-herbicides under b) is greater than the sum of the actions of the active ingredients applied separately.

The herbicidal action to be expected We for a given combination of two herbicides can be calculated as follows (see COLBY, S. R., “Calculating synergistic and antagonistic response of herbicide combinations”, Weeds 15, pages 20-22, 1967):

We=X+[Y·(100−X)/100]

wherein:

X=percentage herbicidal action on treatment with the compound of formula I at a rate of application of p kg per hectare, compared with the untreated control (=0%).

Y=percentage herbicidal action on treatment with a co-herbicide under b) at a rate of application of q kg per hectare, compared with the untreated control.

We=expected herbicidal action (percentage herbicidal action compared with the untreated control) following treatment with the compound of formula I and co-herbicide under b) at a rate of application of p+q kg of active ingredient per hectare.

When the action actually observed is greater than the value to be expected We, there is a synergistic effect.

The synergistic effect of the combinations of the compound of formula I with the co-herbicides under b) is demonstrated in the following Examples.

Experiment Description—Pre-Emergence Test:

Monocotyledonous and dicotyledonous test plants are sown in standard soil in plastics pots. Directly after sowing, the test compounds are applied in aqueous suspension by spraying (500 litres of water/ha). The rates of application depend on the optimum concentrations ascertained under field conditions and greenhouse conditions. The test plants are then grown on in the greenhouse under optimum conditions. The tests are evaluated after 36 days (% action, 100%=plant has died, 0%=no phytotoxic action).

The mixtures used in this test show good results.

Experiment Description—Post-Emergence Test:

Post-emergence application of mixtures of a herbicide of formula I wherein R is CH₃; R₁ is 4-fluorine; R₂ is 3-acetonitrile; and R₃ and R₄ are hydrogen (=herbicide no. 11) with the co-herbicide dicamba at 500 g/ha and 30 g/ha, respectively, in Table B1, and of a herbicide of formula I wherein R is CH₃; R₁ is 4-fluorine; R₂ is 3-acetonitrile; and R₃ and R₄ are hydrogen (=herbicide no. I₁) with the co-herbicide triasulfuron at 250 g/ha and 3.75 g.ha, respectively, in Table B2.

The test plants are grown to the 2- to 3-leaf stage in plastics pots under greenhouse conditions. A standard soil is used as cultivation substrate. At the 2- to 3-leaf stage, the herbicides are applied to the test plants on their own and as a mixture. The application is carried out using an aqueous suspension of the test compounds in 500 litres of water/ha. The rates of application depend on the optimum doses ascertained under field conditions and greenhouse conditions. The tests are evaluated after 33 days (% action, 100%=plant has died, 0%=no phytotoxic action).

Examples of the action of the composition according to the invention are given in Tables B1 and B2.

TABLE B1
Post-emergence application of herbicide no. I₁, alone and in combination with the
co-herbicide dicamba, to winter wheat, winter barley, Galium aparine, Raphnus
raphanistrum, Stellaria media, Veronica persica and Viola tricolor at
500 g/ha and 30 g/ha, respectively; evaluation 20 days after application.

| | Rate of | | | | | | | |
|---|---|---|---|---|---|---|---|---|
| Comp. | application | | | Galium | Raphnus | Stellaria | Veronica | Viola |
| no. | [g a.i./ha] | Wheat | Barley | aparine | raphan. | media | persica | tric. |
| I₁ | 500 | 5 | 0 | 70 | 60 | 50 | 85 | 90 |
| dicamba | 30 | 0 | 10 | 40 | 20 | 20 | 20 | 0 |
| I₁ + dicamba | 500 + 30 | 0 (5) | 0 (10) | 85 (76) | 85 (68) | 80 (60) | 95 (88) | 95 |
| | | | | | | | | (90) |

The expected values, We, for the mixture of compound no. I₁ + dicamba are added in brackets in the above Table B1.

The same results are obtained when the active ingredient mixture is formulated in accordance with the other Formulation Examples given above.

TABLE B2
Post-emergence application of herbicide no. I₁, alone and in combination with the
co-herbicide triasulfuron, to winter wheat, hard wheat, Capsella bursa-pastoris, Galium
aparine, Kochia scoparia, Lamium purpureum, Matricaria chamomilla and Polygonum
convolvulus at 250 g/ha and 3.75 g/ha, respectively; evaluation 10 days after application for
the two useful plants and 20 days after application for the 6 weeds.

| | Rate of | | | | | | | | |
|---|---|---|---|---|---|---|---|---|---|
| | application | | | Caps. | | | | | |
| Comp. | [g | W. | H. | bursa- | Gal. | Kochia | Lamium | Matr. | Polyg. |
| no. | a.i./ha] | wheat | wheat | past. | apar. | scop. | purpur. | cham. | conv. |
| I₁ | 250 | 0 | 0 | 70 | 60 | 95 | 40 | 20 | 60 |
| triasulfuron | 3.5 | 0 | 0 | 98 | 70 | 95 | 90 | 95 | 80 |
| I₁ + triasulfuron | 250 + 3.75 | 0 (0) | 0 (0) | 100 | 95 | 100 | 98 (94) | 98 | 98 |
| | | | | (99) | (88) | (100) | | (96) | (92) |

The expected values, We, for the mixture of compound no. I₁ + triasulfuron are added in brackets in the above Table B2.

The same results are obtained when the active ingredient mixture is formulated in accordance with the other Formulation Examples given above.

It has been shown, surprisingly, that particular safeners are suitable for mixing with the synergistic composition according to the invention. The present invention accordingly relates also to a selectively herbicidal composition for controlling grasses and weeds in crops of useful plants, especially in crops of cereals, rice and maize, that comprises a compound of formula I, one or more compounds selected from the co-herbicides under b), and a safener (counter-agent, antidote) and that protects the useful plants, but not the weeds, against the phytotoxic action of the herbicide, as well as to the use of such a composition in the control of weeds in crops of useful plants.

There is accordingly also proposed in accordance with the invention a selectively herbicidal composition that, in addition to comprising customary inert formulation adjuvants, such as carriers, solvents and wetting agents, comprises as active ingredient a mixture of ab) an amount, effective for herbicide synergy, of a compound of formula I and one or more compounds selected from the co-herbicides under b), and c) an amount, effective for herbicide antagonism, of a compound selected from the compound of formula 3.1

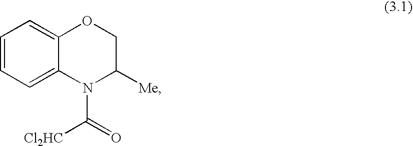

and the compound of formula 3.2

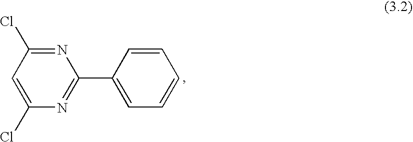

and the compound of formula 3.3

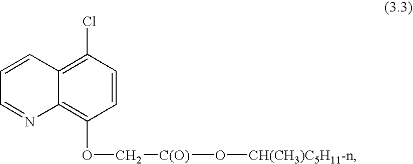

and the free acid and salts thereof, and the compound of formula 3.4

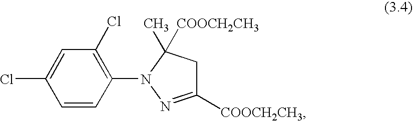

and the free acid and salts thereof, and the compound of formula 3.5

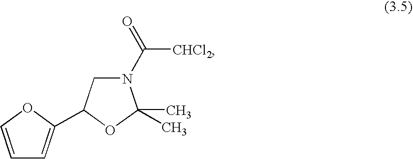

and the compound of formula 3.6

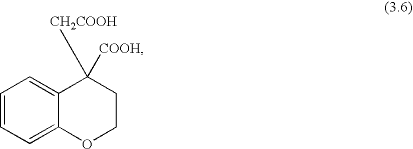

and the compound of formula 3.7

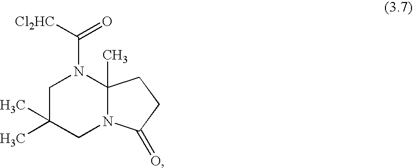

and the compound of formula 3.8

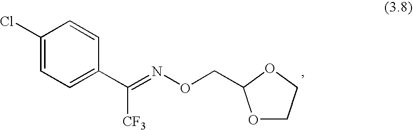

and the compound of formula 3.9

Cl₂CHCON(CH₂CH═CH₂)₂ (3.9)

and the compound of formula 3.10

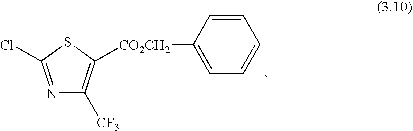

and the compound of formula 3.11

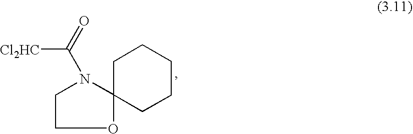

and the compound of formula 3.12

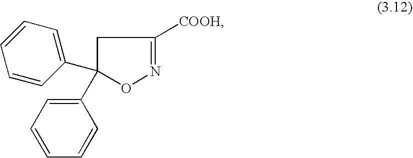

and its ethyl ester, and the compound of formula 3.13

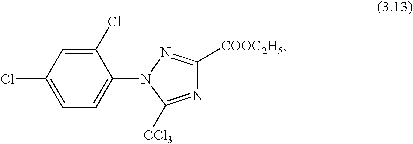

and the compound of formula 3.14

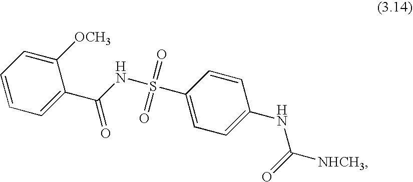

and the compound of formula 3.15

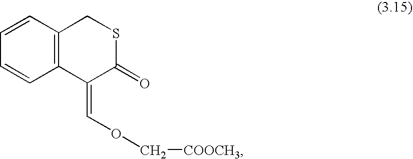

and the compound of formula 3.16

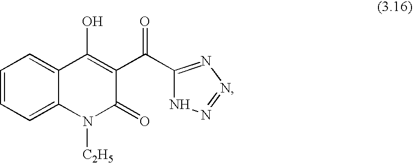

The compounds of formulae 3.1 to 3.16 are known and are described, for example, in “The Pesticide Manual”, 12th Edition, British Crop Protection Council, 2000 under entry numbers 65 (formula 3.1, benoxacor), 325 (formula 3.2, fenclorim), 163 (formula 3.3, cloquintocetmexyl), 492 (formula 3.4, mefenpyr-diethyl), 401 (formula 3.5, furilazole), 389 (formula 3.8, fluxofenim), 225 (formula 3.9, dichlormid) and 376 (formula 3.10, flurazole). The compound of formula 3.11 is known by the name MON 4660 (Monsanto) and is described, for example, in EP-A-0 436 483.

The free acid and salts of cloquintocet-mexyl (formula 3.3) are known, for example, from the PCT Application No. EP01/12187, and the free acid and salts of mefenpyr-diethyl (formula 3.4) are known, for example, from WO 01/17353.

The compound of formula 3.6 (AC 304415) is described, for example, in EP-A-0 613 618, and the compound of formula 3.7 in DE-A-2 948 535. The compounds of formula 3.12 are known under the common name isoxadifen and isoxadifen-ethyl, are described in DE-A-4 331 448 and registered under the CAS Reg. Nos. [209866-92-2] and [163520-33-0], and the compound of formula 3.13 is described in DE-A-3 525 205. The compound of formula 3.14 is known, for example, from U.S. Pat. No. 5,215,570 and the compound of formula 3.15 from EP-A-0 929 543. The compound of formula 3.16 is described in WO 99/00020. In addition to the compound of formula 3.16, the other 3-(5-tetrazolylcarbonyl)-2-quinolones described in WO 99/00020, especially the compounds specifically disclosed in Tables 1 and 2 on pages 21 to 29, are suitable for protecting the crop plants from the phytotoxic action of the compounds of formula I.

The invention relates also to a selectively herbicidal composition that, in addition to comprising customary inert formulation adjuvants, such as carriers, solvents and wetting agents, comprises as active ingredient a mixture of

a) a herbicidally effective amount of a compound of formula I and

c) an amount, effective for herbicide antagonism, of a compound selected from the compounds of formulae 3.1, 3.2, 3.3, 3.4, 3.5, 3.6, 3.7, 3.8, 3.9, 3.10, 3.11, 3.12, 3.13, 3.14, 3.15 and 3.16.

Preferred mixtures according to the invention comprise as safener a compound selected from the compounds of formulae 3.1, 3.3 and 3.8. Those safeners are especially suitable for compositions according to the invention that comprise the above-mentioned preferred co-herbicides under b).

Combinations of a compound of formula I with the compound of formula 3.3 have been shown to be especially effective compositions. Such a composition is preferably used together with clodinafop-propargyl (156).

The invention relates also to a method for the selective control of weeds in crops of useful plants, which comprises treating the useful plants, seeds or cuttings thereof, or the area of cultivation thereof, with a herbicidally effective amount of a herbicide of formula I, optionally one or more herbicides selected from the co-herbicides under b), and an amount, effective for herbicide antagonism, of a safener of formulae 3.1 to 3.16.

As crop plants that can be protected by the safeners of formulae 3.1 to 3.16 against the damaging effect of the above-mentioned herbicides there come into consideration especially cotton, soybeans, sugar beet, sugar cane, plantation crops, rape and, more especially, cereals, rice and maize. “Crops” are to be understood to mean also those crops which have been made tolerant to herbicides or classes of herbicides as a result of conventional methods of breeding or genetic engineering.

The weeds to be controlled may be both monocotyledonous and dicotyledonous weeds, e.g. Stellaria, Agrostis, Digitaria, Avena, Apera, Brachiaria, Phalaris, Setaria, Sinapis, Lolium, Solanum, Echinochloa, Scirpus, Monochoria, Sagittaria, Panicum, Bromus, Alopecurus, Sorghum halepense, Sorghum bicolor, Rottboellia, Cyperus, Abutilon, Sida, Xanthium, Amaranthus, Chenopodium, Ipomoea, Chrysanthemum, Galium, Viola and Veronica.

Areas of cultivation include the areas of ground on which the crop plants are already growing or which have already been sown with the seeds of those crop plants, as well as ground intended for cultivation with such crop plants.

Depending on the intended use, a safener of formula 3.1 to 3.16 can be used in the pretreatment of the seed of the crop plant (dressing of the seeds or cuttings) or can be introduced into the soil before or after sowing. It can, however, also be applied, either alone (so-called “split application”) or together with the herbicide, after emergence of the plants. The treatment of the plants or seeds with the safener can therefore in principle be carried out independently of the time at which the herbicide is applied but implies a period of time in which herbicide and safener are still able to meet in order that the safening action can subsequently come about at all. So-called “split application” must be distinguished from separate application. The plants can, however, also be treated by simultaneous application of herbicide and safener (e.g. in the form of a tank mixture). The ratio of the rate of application of safener to the rate of application of herbicide depends largely on the method of application. In the case of field treatment, which is carried out either using a tank mixture comprising a combination of safener and herbicide or by separate application of safener and herbicide, the ratio of herbicides to safener is generally from 100:1 to 1:10, preferably from 20:1 to 1:1. In the case of field treatment it is usual to apply from 0.001 to 1.0 kg of safener/ha, preferably from 0.001 to 0.25 kg of safener/ha.

The rate of application of herbicides is generally from 0.001 to 2 kg/ha, but preferably from 0.005 to 0.5 kg/ha.

The compositions according to the invention are suitable for all methods of application conventionally used in agriculture, e.g. pre-emergence application, post-emergence application and seed dressing.

In the case of seed dressing, generally from 0.001 to 10 g of safener/kg of seed, preferably from 0.05 to 2 g of safener/kg of seed, are applied. When the safener is applied in liquid form shortly before sowing, with soaking of the seeds, then advantageously the safener solutions used contain the active ingredient in a concentration of from 1 to 10 000 ppm, preferably from 100 to 1000 ppm.

For the purpose of application, the safeners of formulae 3.1 to 3.16 or combinations of those safeners with a herbicide of formula I and, as appropriate, one or more herbicides selected from the co-herbicides under b) are advantageously formulated together with adjuvants customary in formulation technology, e.g. into emulsifiable concentrates, coatable pastes, directly sprayable or dilutable solutions, dilute emulsions, wettable powders, soluble powders, dusts, granules or microcapsules.

Such formulations are described, for example, in WO 97/34485, pages 9 to 13. The formulations are prepared in known manner, e.g. by intimately mixing and/or grinding the active ingredients with liquid or solid formulation adjuvants, e.g. solvents or solid carriers. In addition, surface-active compounds (surfactants) can also be used in the preparation of the formulations. Solvents and solid carriers suitable for that purpose are mentioned, for example, in WO 97/34485, page 6.

Depending on the nature of the compound of formula I, the co-herbicides under b) and safener of formulae 3.1 to 3.16 to be formulated, there come into consideration as surface-active compounds non-ionic, cationic and/or anionic surfactants and surfactant mixtures having good emulsifying, dispersing and wetting properties. Examples of suitable anionic, non-ionic and cationic surfactants are listed, for example, on pages 7 and 8 of WO 97/34485. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol. I-III, Chemical Publishing Co., New York, 1980-81.

The herbicidal formulations usually contain from 0.1 to 99% by weight, especially from 0.1 to 95% by weight, of active ingredient mixture comprising a compound of formula I, a compound selected from the co-herbicides under b) and the safeners of formulae 3.1 to 3.16, from 1 to 99.9% by weight of a solid or liquid formulation adjuvant and from 0 to 25% by weight, especially from 0.1 to 25% by weight, of a surfactant. Whereas commercial products are usually formulated as concentrates, the end user will normally employ dilute formulations.

The compositions may also comprise further ingredients, such as stabilisers, e.g. vegetable oils or epoxidised vegetable oils (epoxidised coconut oil, rapeseed oil or soybean oil), anti-foams, e.g. silicone oil, preservatives, viscosity regulators, binders, tackifiers, and also fertilisers or other active ingredients. For the use of safeners of formulae 3.1 to 3.16, or of compositions comprising them, in the protection of crop plants against the damaging effects of herbicides of formula I and co-herbicides under b), various methods and techniques come into consideration, such as, for example, the following:

i) Seed Dressing

a) Dressing of the seeds with a wettable powder formulation of a compound of formulae 3.1 to 3.16 by shaking in a vessel until uniformly distributed over the seed surface (dry dressing). In that procedure approximately from 1 to 500 g of compound of formulae 3.1 to 3.16 (4 g to 2 kg of wettable powder) are used per 100 kg of seed.

b) Dressing of the seeds with an emulsifiable concentrate of a compound of formulae 3.1 to 3.16 according to method a) (wet dressing).

c) Dressing by immersing the seeds for from 1 to 72 hours in a liquor comprising from 100 to 1000 ppm of a compound of formulae 3.1 to 3.16 and optionally subsequently drying the seeds (immersion dressing).

Dressing the seed or treating the germinated seedling are naturally the preferred methods of application, because treatment with the active ingredients is directed entirely at the target crop. Generally from 1 to 1000 g of antidote, preferably from 5 to 250 g of antidote, are used per 100 kg of seed, but depending on the methodology, which also allows other active ingredients or micronutrients to be added, concentrations above or below the limits indicated may be employed (repeat dressing).

ii) Application as a Tank Mixture

A liquid formulation of a mixture of antidote and herbicide is used (ratio by weight of the one to the other from 10:1 to 1:100), the rate of application of herbicide being from 0.005 to 5.0 kg per hectare. Such tank mixtures are applied before or after sowing.

iii) Application to the Seed Furrow

The compounds of formulae 3.1 to 3.16 are introduced into the open, sown seed furrow in the form of an emulsifiable concentrate, wettable powder or granules. Once the seed furrow has been covered over, the herbicide is applied in the usual manner pre-emergence.

iv) Controlled Release of Active Ingredient

The compounds of formulae 3.1 to 3.16 are applied in solution to mineral granule carriers or polymerised granules (urea/formaldehyde) and dried. If desired, it is also possible to apply a coating that allows the active ingredient to be released in metered amounts over a specific period of time (coated granules).

Preferred formulations have especially the following compositions:

(%=percent by weight)

| | |
|---|---|
| Emulsifiable concentrates: | |
| active ingredient mixture: | 1 to 90%, preferably 5 to 20% |
| surfactant: | 1 to 30%, preferably 10 to 20% |
| liquid carrier: | 5 to 94%, preferably 70 to 85% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surfactant: | 1 to 40%, preferably 2 to 30% |
| Wettable powders: | |
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |
| Granules: | |
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

### FORMULATION EXAMPLES FOR MIXTURES OF HERBICIDES OF FORMULA I, OPTIONALLY CO-HERBICIDES B), AND SAFENERS OF FORMULAE 3.1 TO 3.16 (%=PERCENT BY WEIGHT)

| F1. Emulsifiable concentrates | a) | b) | c) | d) |
|---|---|---|---|---|
| active ingredient mixture | 5% | 10% | 25% | 50% |
| calcium dodecylbenzene- | 6% | 8% | 6% | 8% |
| sulfonate | | | | |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon | 85% | 78% | 55% | 16% |
| mixture C₉-C₁₂ | | | | |

Emulsions of any desired concentration can be obtained from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol mol. wt. 400 | 20% | 10% | — | — |
| N-methyl-2-pyrrolidone | — | — | 30% | 10% |
| arom. hydrocarbon | 75% | 60% | — | — |
| mixture C₉-C₁₂ | | | | |

The solutions are suitable for use in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly disperse silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly disperse silicic acid | 0.9% | 2% | 2% |
| inorg. carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol mol. wt. 200 | 1.0% | 2% | 3% |
| highly disperse silicic acid | 0.9% | 1% | 2% |
| inorg. carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the compounds of formula I, co-herbicides under b) and safeners of formulae 3.1 to 3.16 to be formulated separately and then to be brought together in the desired mixing ratio in the applicator in the form of a “tank mixture” in water shortly before application.

The ability of the safeners of formulae 3.1 to 3.16 to protect crop plants against the phytotoxic action of herbicides of formula I is illustrated in the following Example.

### BIOLOGICAL EXAMPLE: SAFENING ACTION

The test plants are grown in plastics pots under greenhouse conditions to the 4-leaf stage. At that stage, either the herbicides alone or the mixtures of the herbicides with the test compounds being tested as safeners are applied to the test plants. The test compounds are applied in the form of an aqueous suspension prepared from a 25% wettable powder (Example F3, b)) with 500 litres of water/ha. 4 weeks after application, the phytotoxic action of the herbicides on the crop plants, e.g. maize and cereals, is evaluated using a percentage scale. 100% indicates that the test plant has died, 0% indicates no phytotoxic action. The mixtures according to the invention show good action in this test.

What is claimed is:

1. A selectively herbicidal composition that, in addition to comprising customary inert formulation adjuvants, comprises as active ingredient a mixture of
a) a herbicidally effective amount of a compound of formula I 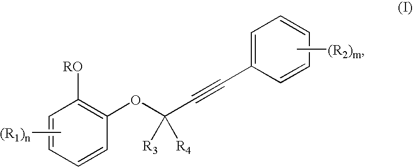
wherein
R is H, —COR₁₂, —S(O)_{q}C₁₋₈alkyl, C₁₋₈alkyl which is unsubstituted or substituted by one or more substituents selected from halogen, C₁₋₄alkoxy, —CN, —S(O)_{q}C₁₋₈alkyl and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, C₃₋₈alkenyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, C₃₋₈alkynyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, C₃₋₆cycloalkyl which is unsubstituted or substituted by one or more substituents selected from halogen, C₁₋₄alkoxy, —CN and phenyl which in turn is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl, or phenyl which is unsubstituted or substituted by one or more substituents selected from halogen, —CH₃, —CF₃, —OCH₃, —CN, —NO₂ and —S(O)_{q}C₁₋₈alkyl; and,
when n is 0, 1, 2 or 3, R may, in addition, form a C₁₋₆alkylene bridge which is uninterrupted or interrupted by 1 O atom, the possibility of an —O—O— bond being excluded, and that bridge, fused onto the benzene ring, forming a 5- to 9-membered ring which may in turn be substituted by CO₁₋₆alkyl, or may form a C₂₋₆alkenylene bridge which is uninterrupted or interrupted by 1 O atom, the possibility of an —O—O— bond being excluded, and that bridge, fused onto the benzene ring, forming a 5- to 9-membered ring which may in turn be substituted by C₁₋₆alkyl, the said alkylene or alkenylene bridge being bonded to the benzene ring at the 3-position;
R₁ is halogen, —CN, —SCN, —SF₅, —NO₂, —NR₅R₆, —CO₂R₇, —CONR₈R₉, —C(R₁₀)═NOR₁₁, —COR₁₂, —XR₁₃, C₁₋₈alkyl which is unsubstituted or substituted by one or more substituents selected from halogen, —CN, —NO₂, —NR₅R₆, —CO₂R₇, —CONR₈R₉, —COR₁₂, —C(R₁₀)═NOR₁₁, —C(S)NR₈R₉, —C(S—C₁₋₄alkyl)═NR₈, —XR₁₃ and C₃₋₆cycloalkyl, C₂₋₈alkenyl which is unsubstituted or substituted by one or more substituents selected from halogen, —CN, —NO₂, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, C₂₋₈alkynyl which is unsubstituted or substituted by one or more substituents selected from halogen, —CN, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, C₃₋₆cycloalkyl which is unsubstituted or substituted by one or more substituents selected from halogen, —CN, —CO₂R₇, —CONR₈R₉, —COR₁₂, —C(R₁₀)═NOR₁₁, —C(S)NR₈R₉ and —C(S—C₁₋₄alkyl)═NR₈, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl; or
two adjacent R₁ radicals together form a C₁₋₇alkylene bridge which may be interrupted by 1 or 2 non-adjacent O atoms and that bridge, fused onto the benzene ring, forms a 5- to 9-membered ring which may be substituted by C₁₋₆alkyl; or
two adjacent R₁ radicals together form a C₂₋₇alkenylene bridge which may be interrupted by 1 or 2 non-adjacent O atoms and that bridge, fused onto the benzene ring, forms a 5- to 9-membered ring which may be substituted by C₁₋₆alkyl;
R₂ is halogen, —CN, —SCN, —SF₅, —NO₂, —NR₅R₆, —CO₂R₇, —CONR₈R₉, —C(R₁₀)═NOR₁₁, —COR₁₂, —XR₁₃, —OR₁₆, —N([CO]ₚR₁₇)COR₁₇, —N(OR₁₇)COR₁₇, —N(R₁₇)CO₂R₁₇, —N-phthalimide, C₁alkyl which is unsubstituted or substituted by one or more substituents selected from halogen, —CN, —NO₂, —NR₅R₆, —CO₂R₇, —CONR₈R₉, —COR₁₂, —C(R₁₀)═NOR₁₁, —C(S)NR₈R₉, —C(S—C₁₋₄alkyl)═NR₈, —XR₁₃, —N(R₁₄)CO₂R₁₅, —N(R₁₄)COR₁₅ and C₃₋₆cycloalkyl, C₂₋₈alkenyl which is unsubstituted or substituted by one or more substituents selected from halogen, —CN, —NO₂, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, C₂₋₈alkynyl which is unsubstituted or substituted by one or more substituents selected from halogen, —CN, —CO₂R₇, —CONR₈R₉, —COR₁₂, —C(R₁₀)═NOR₁₁, —C(S)NR₈R₉, —C(S—C₁₋₄alkyl)═NR₈ and C₃₋₆cycloalkyl, or C₃₋₆cycloalkyl which is unsubstituted or substituted by one or more substituents selected from halogen, —CN, —CO₂R₇, —CONR₈R₉, —COR₁₂, —C(R₁₀)═NOR₁₁, —C(S)NR₈R₉ and —C(S—C₁₋₄alkyl)═NR₈; or
two adjacent R₂ radicals together form a CO₁₋₇alkylene bridge which may be interrupted by 1 or 2 non-adjacent O atoms and that bridge, fused onto the benzene ring, forms a 5- to 9-membered ring which may be substituted by C₁₋₆alkyl; or
two adjacent R₂ radicals together form a C₂₋₇alkenylene bridge which may be interrupted by 1 or 2 non-adjacent O atoms and that bridge, fused onto the benzene ring, forms a 5- to 9-membered ring which may be substituted by C₁₋₆alkyl;
R₅ is H or C₁₋₈alkyl;
R₆ is H, C₁₋₈alkyl, C₃₋₈alkenyl, C₃₋₈alkynyl, benzyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, or phenyl which is unsubstituted or substituted by one or more substituents selected from halogen, CO₁₋₄alkyl, halo-C₁₋₄alkyl, C₁₋₄alkoxy, —CN, —NO₂ and —S(O)_{q}C₁₋₈alkyl; or
R₅ and R₆ together form a C₂₋₅alkylene bridge;
R₇ is H, C₁₋₈alkyl which is unsubstituted or substituted by one or more substituents selected from halogen and C₁₋₄alkoxy, C₃₋₈alkenyl which is unsubstituted or substituted one or more times by halogen, C₃₋₈alkynyl which is unsubstituted or substituted one or more times by halogen, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl;
R₈ is H or C₁₋₈alkyl;
R₉ is H, C₁₋₈alkyl which is unsubstituted or substituted by one or more substituents selected from —CO₂R₈ and —CN, C₃₋₈alkenyl, C₃₋₈alkynyl, C₁₋₄alkoxy, benzyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl, or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl; or
R₈ and R₉ together form a C₂₋₅alkylene bridge;
R₉ is H, C₁₋₄alkyl, halo-C₁₋₄alkyl or C₃₋₆cycloalkyl;
R₁₁ is H, CO₁₋₈alkyl, C₃₋₈alkenyl, C₃₋₈alkynyl or halo-C₁₋₄alkyl;
R₁₂ is H, C₁₋₄alkyl, halo-C₁₋₄alkyl or C₃₋₆cycloalkyl;
R₁₃ is C₁₋₈alkyl which is unsubstituted or substituted by one or more substituents selected from halogen, —CN and C₁₋₄alkoxy, C₃₋₈alkenyl or C₃₋₈alkynyl or, provided that X is —O— or —S—, R₁₃ may, in addition, be H;
R₁₄ is H, CO₁₋₈alkyl or C₁₋₈alkoxy;
R₁₅ is H or CO₁₋₈alkyl;
R₁₆ is C₀₋₆alkylphenyl which is unsubstituted or substituted by one or more substituents selected from halogen, C₁₋₄alkyl, halo-C₁₋₄alkyl, C₁₋₄alkoxy, —CN, —NO₂ and —S(O₂)C₁₋₈alkyl;
R₁₇ is H, C₁₋₈alkyl or phenyl which is unsubstituted or substituted by one or more substituents selected from halogen, C₁₋₄alkyl, halo-C₁₋₄alkyl, C₁₋₄alkoxy, —CN, —NO₂ and —S(O)_{q}C₁₋₈alkyl;
X is —O—, —S—, —SO—, —S(O₂)— or —OS(O₂)—;
R₃ and R₄, each independently of the other, is H, halogen, —CN, C₁₋₄alkyl or C₁₋₄alkoxy; or
R₃ and R₄ together form a C₂₋₅alkylene bridge;
n is 0, 1, 2, 3 or 4;
m is 0, 1, 2, 3, 4 or 5; the sum of n and m being 1 or more than 1;
p is 0 or 1; and
q is 0, 1 or 2,
or an agronomically acceptable salt of such a compound, and
b) a synergistically effective amount of one or more compounds selected from the group consisting of the co-herbicides:
triasulfuron (773), prosulfuron (657), clodinafop-propargyl (156), terbutryn (740), dicamba (222), fenoxaprop-P-ethyl (331), metamifop, diclofop-methyl (232), tralkoxydim (767), butroxydim (104), amidosulfuron (24), chlorsulfuron (146), ethoxysulfuron (307), flupyrsulfuron (374), flupyrsulfuron-methyl-sodium (374), metsulfuron-methyl (536), sulfosulfuron (714), thifensulfuron-methyl (754), tribenuron-methyl (778), imazamethabenz-methyl (438), flucarbazone-sodium (357), iodosulfuron-methyl-sodium (454), florasulam (351), flumetsulam (366), metosulam (533), chlorotoluron (142), isoproturon (464), methabenzthiazuron (510), bromoxynil (93), ioxynil (455), pyridate (672), bifenox (75), fluoroglycofen-ethyl (371), carfentrazone-ethyl (119), fluazolate (355), diflufenican (245), flurtamone (382), glyphosate (407), sulfosate (407), glufosinate (406), S-glufosinate, bialaphos (bilanafos; (77)), ethalfluralin (298), pendimethalin (599), 2,4-DB (211), dichlorprop (2,4-DP; (228)), MCPA (485), MCPB (487), mecoprop (MCPP; (489)), mecoprop-P (490), clopyralid (162), fluroxypyr (380), quinmerac (682), benazolin-ethyl (59), difenzoquat metilsulfate (242), cyhalofop-butyl (191), trifluralin (791), fluthiamide (flufenacet; (362)), isoxaben (466), prosulfocarb (656), triallate (772), 2,4-D (205); benfluamid, cinidon-ethyl (152), flufenpyr, picolinafen (code no. AC 900001; (621)), propoxycarbazone (code no. MKH 6561; (541)); pretilachlor (632), cinosulfuron (154), fenclorim (325), pyriftalid (code no. CGA 279 233), metolachlor (529), S-metolachlor (530), mixtures of metolachlor and S-metolachlor, preferably mixtures thereof that contain 50-90%, especially 70-90%, S-metolachlor, bensulfuron-methyl (66), imazosulfuron (444), pyrazosulfuron-ethyl (665), azimsulfuron (45), esprocarb (296), mefenacet (491), molinate (542), propanil (644), pyrazolate (pyrazolynate; (663)), fenoxaprop-ethyl (“The Pesticide Manual”, Editor C. Tomlin, 10th Edition, British Crop Protection Council, 1994, entry no. (299)), bispyribac (82), bispyribac-sodium (82), pyriminobac-methyl (676), cafenstrole (108), oxaziclomefone (code no. MY-100; (583)), dymron (daimuron; (207)), fentrazamide (code no. NBA 061; (340)), indanofan (code no. MK243; (450)), etobenzanid (code no. HW-52; (311)), oxadiargyl (578), halosulfuron-methyl (414), clomazone (159), oxadiazon (579), benzobicyclon (code no. SAN1315H; (70)), mefenpyr-diethyl (492); profoxydim (code no. BAS 625H; (54)), pyrazogyl; cyclosulfamuron (186), flazasulfuron (349), flufenacet (362), benfuresate (63), bentazone (69), bromobutide (91), dithiopyr (275), ethametsulfuron-methyl (299), flamprop-M (348), methyldymron (521), quinclorac (681), thiazopyr (752) and mesosulfuron.

2. A method of controlling undesired plant growth in crops of useful plants, which comprises allowing a herbicidally effective amount of a composition according to claim 1 to act on the crop plant or the locus thereof.

3. A method according to claim 2, wherein the crop plant is a cereal, rice or maize.

4. A method according to claim 2, wherein the crops of useful plants are treated with the mentioned composition at rates of application corresponding to a total amount of active ingredient of from 1 to 5000 g per hectare.

5. A selectively herbicidal composition that, in addition to comprising customary inert formulation adjuvants, such as carriers, solvents and wetting agents, comprises as active ingredient a mixture of
ab) an amount, effective for herbicide synergy, of a compound of formula I according to claim 1 and one or more compounds selected from the co-herbicides under b) according to claim 1, and
c) an amount, effective for herbicide antagonism, of a compound selected from the compound of formula 3.1 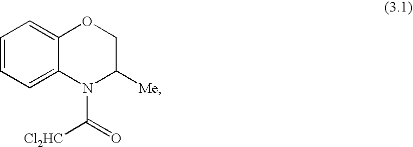
and the compound of formula 3.2 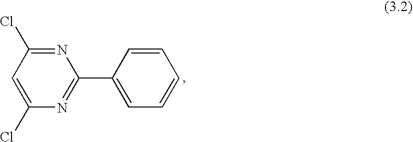
and the compound of formula 3.3 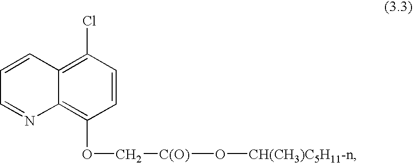
and the free acid and salts thereof, and the compound of formula 3.4 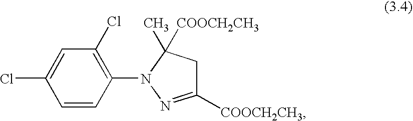
and the free acid and salts thereof, and the compound of formula 3.5 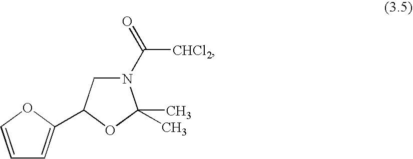
and the compound of formula 3.6 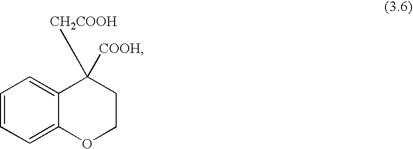
and the compound of formula 3.7 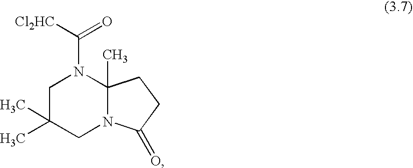
and the compound of formula 3.8 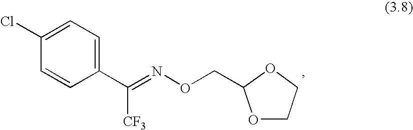
and the compound of formula 3.9
Cl₂CHCON(CH₂CH═CH₂)₂ (3.9),
and the compound of formula 3.10 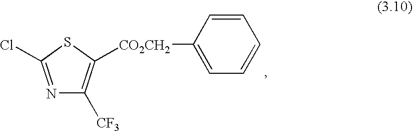
and the compound of formula 3.11 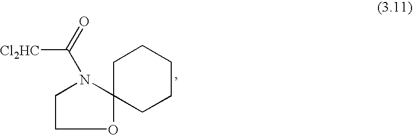
and the compound of formula 3.12 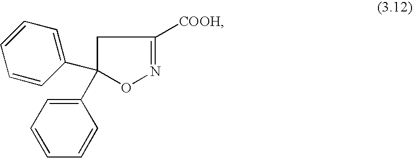
and its ethyl ester, and the compound of formula 3.13 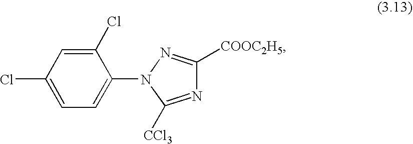
and the compound of formula 3.14 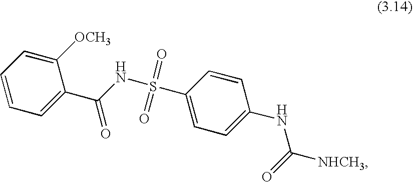
and the compound of formula 3.15 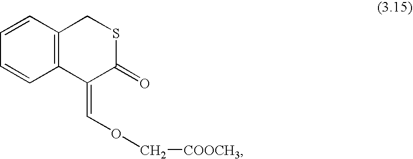
and the compound of formula 3.16

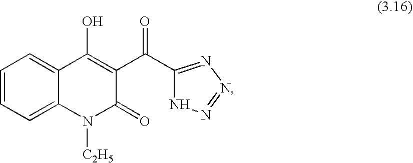

6. A method for the selective control of weeds and grasses in crops of useful plants, which comprises treating the useful plants, seeds or cuttings thereof, or the area of cultivation thereof, with an amount, effective for herbicide synergy, of a composition according to claim 5.

7. A method according to claim 6, wherein the rate of application of herbicides is from 1 to 5000 g/ha and the rate of application of safener is from 0.001 to 0.5 kg/ha.

8. A method according to claim 6, wherein the useful plant crop is a cereal, rice or maize.

9. A selectively herbicidal composition that, in addition to comprising customary inert formulation adjuvants, such as carriers, solvents and wetting agents, comprises as active ingredient a mixture of
a) a herbicidally effective amount of a compound of formula I according to claim 1, and
c) an amount, effective for herbicide antagonism, of a compound selected from the compound of formula 3.1 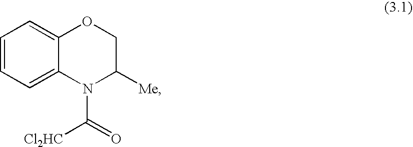
and the compound of formula 3.2 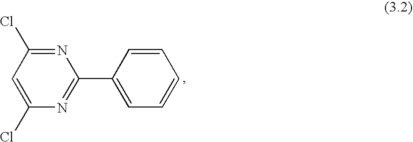
and the compound of formula 3.3 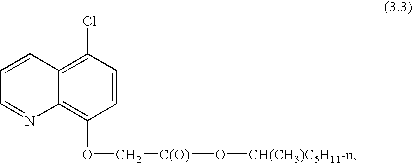
and the free acid and salts thereof, and the compound of formula 3.4 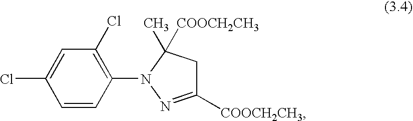
and the free acid and salts thereof, and the compound of formula 3.5 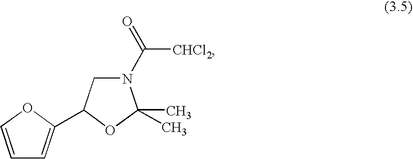
and the compound of formula 3.6 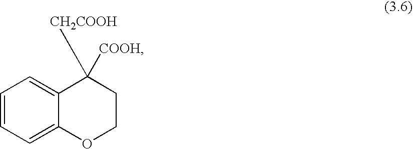
and the compound of formula 3.7 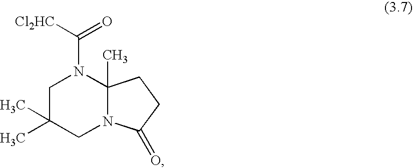
and the compound of formula 3.8 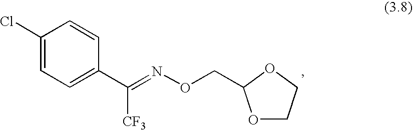
and the compound of formula 3.9
Cl₂CHCON(CH₂CH═CH₂)₂ (3.9),
and the compound of formula 3.10 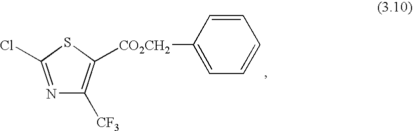
and the compound of formula 3.11 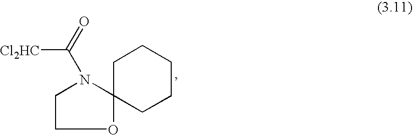
and the compound of formula 3.12 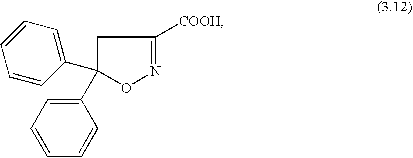
and its ethyl ester, and the compound of formula 3.13 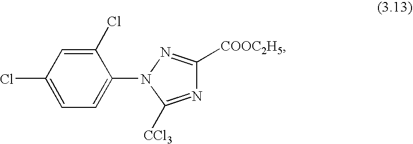
and the compound of formula 3.14 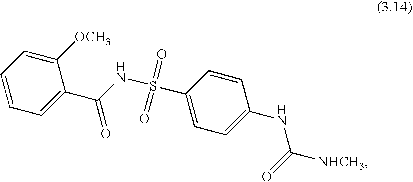
and the compound of formula 3.15 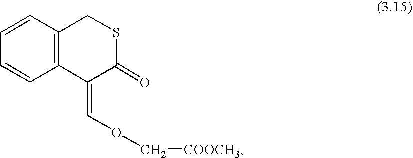
and the compound of formula 3.16

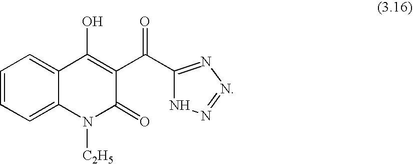

10. A method for the selective control of weeds and grasses in crops of useful plants, which comprises treating the useful plants, seeds or cuttings thereof, or the area of cultivation thereof, with an amount, effective for herbicide synergy, of a composition according to claim 9.
